(19) United States
(12) Patent Application Publication
(10) Pub. No.: US 2005/0175317 A1
(43) Pub. Date: Aug. 11, 2005

(54) Method of converting file system format and apparatus thereof

(75) Inventors: Hyun-kwon Chung, Seoul (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/009,406

(22) Filed: Dec. 13, 2004

(30) Foreign Application Priority Data
Dec. 13, 2003 (KR) 2003-90970

(51) Int. Cl. H04N 5/76; H04N 5/781; G11B 27/00

(52) U.S. Cl. 386/52; 386/131

(57) ABSTRACT

A method and apparatus converting a Bluray disc file system (BDFS) format recorded on an optical disc into a universal disc format (UDF), the method including: recording information on a reserved area including a management information area of the BDFS format as a system file of the UDF format; and converting BDFS format file data into UDF format file data. Accordingly, compatibility between a data recording and/or reproducing apparatus complying with BDFS file system format and an apparatus complying with the UDF file system format can be guaranteed.

### CROSS-REFERENCE TO RELATED APPLICATION

This application claims the benefit of Korean Patent Application No. 2003-90970, filed on Dec. 13, 2003 in the Korean Intellectual Property Office, the disclosure of which is incorporated herein by reference.

### BACKGROUND OF THE INVENTION

1. Field of the Invention

The present invention relates to a file system of an optical disc, and more particularly, to a method and apparatus converting a format between a Bluray disc file system (BDFS) format used in a Bluray disc and a universal disc format (UDF) that is a general purpose disc format.

2. Description of the Related Art

In order to record or retrieve data in a computer, preparation for reading and retrieving data from, and writing data on a storage medium such as a hard disc drive or an optical disc should be performed beforehand. A file system is an arrangement of rules and is a system, indicating, for example, how to name a file and where to place a file logically for storage or retrieval. Operating systems, such as DOS, Windows, OS/2, Macintosh, UNIX, have file systems. Examples of the file systems include FAT16, FAT32, and NTFS of Windows and ext2, raiserFS, and ext3 of Linux.

A file is located at a directory (a folder, after Windows 95) or subdirectory in a hierarchical structure. A file system has a rule for naming a file. This rule includes the length limit of a file name, and which characters can be used, and in some systems, there is a limit also in the length of the file name extension. The file system includes a format setting a path to a file through a directory structure.

Meanwhile, an optical disc is a storage medium capable of recording a large volume of multimedia data and leading examples include a digital versatile disc (DVD) and a Bluray disc. Since the DVD stores data by using the UDF format that is a universal disc format, data can be read from and written on the DVD in a personal computer using the UDF format as well as a DVD reproducing apparatus.

In case of the Bluray disc that has been under development recently, 20 GB or more multimedia data and HD level high picture quality images with a length of 2 hours can be recorded. However, in case of a consumer electronics type Bluray disc recording and/or reproducing apparatus recording moving pictures on a Bluray disc, a Bluray disc file system (hereinafter referred to as “BDFS”) format is used to record data. Accordingly, there is a problem that in an operating system running on a personal computer using the UDF format, a file stored in a Bluray disc cannot be read or a file cannot be written on the Bluray disc. This is because the operating system of the personal computer cannot interpret the file system in this BDFS format.

Furthermore, in addition to being unable to read data recorded in the BDFS format, there is a problem that a recording space remaining after recording moving picture data cannot be utilized as a space for recording data for a personal computer.

### SUMMARY OF THE INVENTION

According to an aspect of the present invention there is provided a method and apparatus converting a format between a Bluray disc file system (BDFS) format used in a Bluray disc and a universal disc format (UDF) that is a general purpose disc format.

According to an aspect of the present invention, there is provided a method of converting a first format file system into a second format file system, including: recording on a predetermined reserved area, including a management information area of the first format file system, system data of the second format file system; and converting first file data of the first format file system into second file data of the second format file system.

According to another aspect of the present invention, the file system of the first format may be a file system of a Bluray disc file system (BDFS) format recorded on an optical disc and the file system of the second format may be a file system of a universal disc format (UDF).

According to another aspect of the present invention, the recording of the system data of the second format file system may include: moving the management information area in the BDFS format into a normal data area in the BDFS format and recording the area; and reserving the area previously used for the management information area so as to prevent use of the area by other files.

According to another aspect of the present invention, the converting into the normal file data of the second format file system may include: by interpreting information recorded in the management information area, generating a file system structure in the UDF format; linking control information of files in the file system in the UDF format to refer to file data in the normal data area; generating the volume structure of the UDF format; and deleting information related to the file system in the BDFS format.

According to another aspect of the present invention, there is provided a method of converting a second format file system into a first format file system, including: copying information of a management information area of the first format file system recorded as system data of the second format file system, into a predetermined area reserved beforehand; and converting a second file data of the second format file system into first file data of the first format file system.

According to another aspect of the present invention, the copying of the information of a management information area of the first format file system into a predetermined area reserved beforehand includes: generating a management information area in the BDFS format in the predetermined reserved area; and copying the UDF format management information in the generated management information area.

According to another aspect of the present invention, the converting into file data of the first format file system may include: generating file control information in the management information area; linking the file control information to refer file data of the normal data area in the BDFS format; generating an anchor information area indicating the location of the management information area in the BDFS format; and deleting information related to the file system in the UDF format.

According to still another aspect of the present invention, there is provided a method of converting a Bluray disc file system (BDFS) format recorded on an optical disc into a universal disc format (UDF) including: converting the extent of a file into the location and length of the extent, the length of a recorded area, and the length of an information area, by using a start offset and an end offset; and converting file data in the BDFS format into file data in the UDF format by using the converted extent.

According to yet still another aspect of the present invention, there is provided an apparatus providing a conversion function between a first format file system into a second format file system, including: a unit recording a predetermined reserved area including a management information area of the first format file system, as system data of the second format file system; a unit converting a first file data of the first format file system into a second file data of the second format file system; and a unit converting file data of the second format file system into file data of the first format file system.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become more apparent and more readily appreciated from the following description of the embodiments, taken in conjunction with the accompanying drawings of which:

FIG. 1 is a reference diagram illustrating an apparatus converting a file system format according to an aspect of the present invention;

FIG. 2 is a diagram illustrating the format of a Bluray disc file system (BDFS);

FIG. 3 is a diagram illustrating a universal disc format (UDF) used in a personal computer;

FIG. 4 is a flowchart of the operations for converting the BDFS format into the UDF format according to an aspect of the present invention;

FIG. 5 is a diagram illustrating the result of converting the BDFS format into the UDF format according to an aspect of the present invention;

FIG. 6 is a flowchart of the operations for converting the UDF format into the BDFS format according to an aspect of the present invention;

FIG. 7 is a diagram illustrating the structure of a root directory used in the UDF format and the BDFS format;

FIG. 8 is a diagram illustrating file extent information included in file control information;

FIG. 9 is a diagram illustrating file extent information in the BDFS format;

FIG. 10 is a diagram illustrating file extent information in the UDF format converted according to an aspect of the present invention;

FIG. 11 is a diagram illustrating an extended allocation descriptor complying with ECMA 167 standard to implement file extent information in the converted UDF format according to an aspect of the present invention; and

FIG. 12 is a flowchart of the operations for converting file extent information in the converted UDF format according to an aspect of the present invention.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

In order to record a file on a disc, a system format that is a logical format should be formed on a disc. If system formatting is performed in the conventional consumer electronics type Bluray disc recording and/or reproducing apparatus, the disc is formatted in the BDFS format, while in the conventional PC operating system, the disc is formatted in the UDF format. Accordingly, data recorded on an optical disc in the consumer electronics type Bluray disc recording and/or reproducing apparatus cannot operate in an ordinary PC. This is because the operating system of the PC cannot interpret the file in the BDFS format. Accordingly, data on an optical disc recorded in the BDFS file system format should be converted into the UDF file system format so that it can be read and written in an ordinary PC.

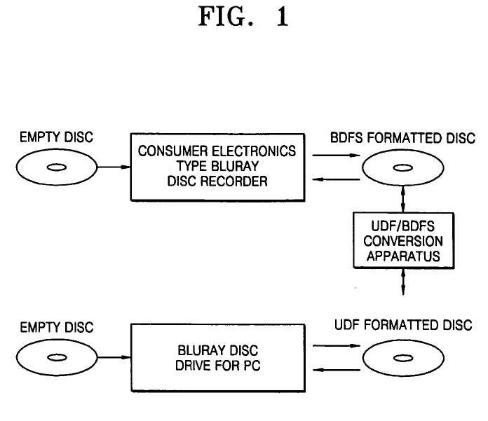

FIG. 1 is a reference diagram illustrating an apparatus converting a file system format according to an aspect of the present invention. Referring to FIG. 1, shown is a UDF/BDFS file conversion apparatus (hereinafter referred to as a “file conversion apparatus”) converting a BDFS file system format of an optical disc into a UDF file system format and vice versa. Only after the file system is converted by using this file conversion apparatus, compatibility between a consumer electronics type Bluray disc recording and/or reproducing apparatus and a disc drive for a PC can be guaranteed.

The BDFS and UDF file systems will now be explained and then a mutual conversion method will be explained in more detail.

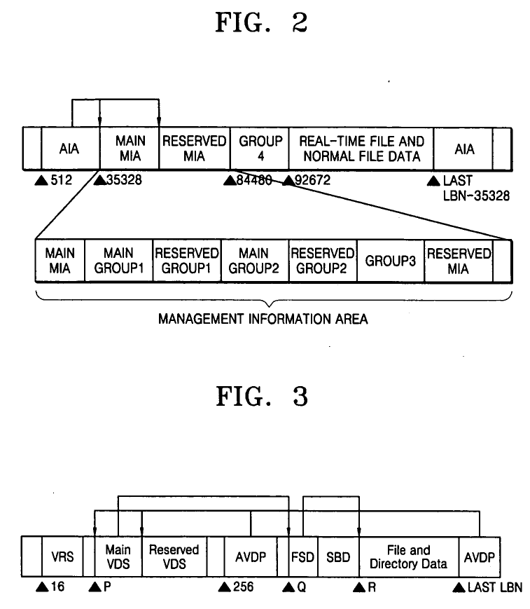

FIG. 2 is a diagram illustrating the format of the BDFS.

Referring to FIG. 2, the BDFS file system format includes a management information area, an anchor information area and a real-time file and normal file data area.

The management information area (hereinafter referred to as an “MIA”) includes file system control information for files and directories, and is recorded on the disc as two areas, a main MIA and a reserved MIA. The MIA is recorded on a disc in an area from 35328 logical block number (hereinafter referred to as an “LBN”) address to 84479 LBN address. Generally, the LBN is a sector unit. More specifically, in the MIA, in addition to file system control information on files and directories, files of groups 1 through 3 classified into three types can be recorded. Also, files of group 4 are recorded in an area from 84489 LBN to 92671 LBN on the disc following the reserved MIA. Playlist files and clip information files, used as files for navigation for example, are recorded in groups 1 and 2, and thumbnail navigation data or image files, such as for example a menu, are recorded in groups 3 and 4. More specifically, in groups 1 through 4, files such as info.bdav, menu.tidx, menu.tdt1, menu.tdt2, mark.tidx, mark.tdt1, mark.tdt2, and real playlist, virtual playlist, clip information, can be recorded.

The anchor information area (AIA) includes information indicating the location of the recently updated MIA. The anchor information area is recorded at the start part and end part of the disc.

The real-time file and normal file data area is a location where actual moving picture files or other ordinary data files are recorded, and such data is recorded on an area from 92672 LBN to an address corresponding to a value obtained by subtracting 35328 LBN from the last LBN.

Meanwhile, FIG. 3 is a diagram illustrating a UDF format used in a PC.

Referring to FIG. 3, the UDF file system format includes VRS, VDS, AVDP, FSD, SBD, and file and directory data areas.

VRS denotes a volume recognition sequence and includes information indicating that the optical disc is formatted in the UDF file system format. VRS is recorded from address 16LBN on the disc. VDS denotes a volume descriptor sequence in which information on the volume structure of the optical disc is recorded. VDS is recorded in the location of p LBN, P being an arbitrary value between 16 LBN and 256 LBN. VDS indicates a location in which the file set descriptor (FSD) that is information describing the structure of a file. AVDP denotes an anchor volume descriptor pointer, in which the location information of VDS is recorded. AVDP is recorded on the disc between address 256 LBN and the last LBN. FSD is information describing a file structure and in FSD, the address at which the root directory of a file system is located is recorded. SBD, denoting a space bitmap descriptor, is space management information and in SBD, a space bitmap descriptor collectively managing unallocated areas in a volume space is recorded. File and directory data is an area in which ordinary data files and directory information is recorded. File and directory data is recorded after address R LBN.

A method of converting the BDFS format described above into the UDF format will now be explained.

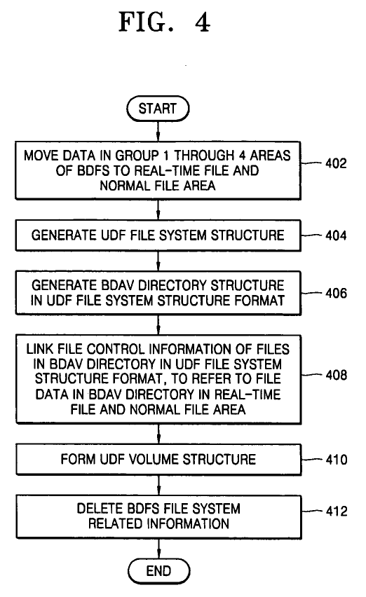

FIG. 4 is a flowchart of operations performed for converting the BDFS format into the UDF format according to an aspect of the present invention. Referring to FIG. 4, in order to convert the BDFS format into the UDF format, first data in group 1 through group 4 areas of the BDFS is moved to the real-time file and normal file data area in operation 402. Accordingly, files included in the group 1 through group 4 areas, info.bdav, menu.tidx, menu.tdt1, menu.tdt2, mark.tidx, mark.tdt1, mark.tdt2, real playlist, virtual playlist, and clip information, and so on, are moved into the real-time file and normal file data area.

Next, a UDF file system structure is generated in operation 404. That is, address 512 is allocated at Q, that is the location of the FSD which is the file structure description information, and an FSD is generated. Also, information of the MIA of the BDFS is interpreted and file extent information of files in the real-time file and normal file data area is interpreted to generate an SBD that is space management information of the UDF.

Next, a BDAV directory is generated in the form of a directory format in the UDF file system in operation 406. That is, in the normal file and directory data area of the UDF, root directory information and system stream directory information are generated. Also, in order to reserve the area from 35328 LBN to 92671 LBN used by the MIA and group 4 area in the BDFS file system format so that other files in the UDF file system format cannot use this area, a special system file (for example, BDFS_Reserved.sys) is generated and allocated to this area.

Next, file control information of files in the BDAV directory generated in the UDF file system structure format is linked to the real-time file and normal file data area in operation 408. That is, conversion is performed such that data files in the BDAV directory of the converted UDF file system format come to refer to the real-time moving picture files or normal data files in the BDAV directory of the original BDFS file system format so as to be able to read the existing data files. Accordingly, in the normal file and directory data area of the converted UDF file system, the root directory is located at R LBN of the UDF file system format, and there is a special system file (for example, BDFS_Reserved.sys) to prevent the use of the MIA and group 4 area. Also, there is the file control information (Information Control Block, hereinafter referred to as an “ICB”) of the files recorded in group 1 through group 4 areas, info.bdav, menu.tidx, menu.tdt1, menu.tdt2, mark.tidx, mark.tdt1, mark.tdt2, real playlist, virtual playlist, and clip information, and so on, and also, there are the ICB of the BDAV directory, the ICB of subdirectories below, and directory data.

Next, a UDF volume structure is generated in operation 410. That is, at address 16 LBN area on the disc, a VRS indicating the UDF file system format is generated. Also, arbitrary P LBN is allocated in an area before address 512 LBN on the disc such that a VDS describing the volume structure is generated. Furthermore, an AVDP that is location information indicating the location of the VDS that is information on the volume structure of the optical disc is generated at 256 LBN and the last LBN.

Finally, BDFS file system related information is deleted in operation 412.

Accordingly, a recording and/or reproducing apparatus of the Bluray disc according to an aspect of the present invention is made to be unable to recognize the existence of the changed BDFS file system such that confusion of the converted file system or consequent error occurrence can be prevented.

The method of converting the BDFS file system format into the UDF file system format described above can be broken down and summarized as follows:

1) The files in group 1 through group 4 areas of the BDFS (info.bdav, menu.tidx, menu.tdt1, menu.tdt2, mark.tidx, mark.tdt1, mark.tdt2, real playlist, virtual playlist, and clip information, and so on) are moved into the real-time file and normal file data area.

2) Address 512 is allocated to Q LBN of the UDF

3) The FSD of the UDF is generated.

4) By interpreting the ICB of the MIA, the extent of files of the real-time file and normal filed data area is interpreted.

5) The SBD of the UDF is generated and the interpreted extent is expressed as sector information allocated in the SBD.

6) In the file and directory area of the UDF, root directory information and system stream directory information are generated.

7) A special system file (for example, BDFS_Reserved.sys) is generated and allocated in the area from 35238 LBN to 92671 LBN which is used as the MIA and the file storage area of group 4 in the BDFS file system format so that other files cannot use this area.

8) By interpreting information of the MIA, file and directory information of the real-time file and normal file data area are converted into a UDF file and directory data area and then recorded. At this time, among the ICBs generated on the UDF, the extent of a file is linked to the address of the extent of data stored in the real-time and normal file data area in the BDFS format. Accordingly, the root directory is located at R LBN of the UDF and a special system file (for example, BDFS_Reserved.sys) is generated to prevent the use of the MIA and group 4 area, the ICB of files, including info.bdav, menu.tidx, menu.tdt1, menu.tdt2, mark.tidx, mark.tdt1, mark.tdt2, real playlist, virtual playlist, and clip information, and so on, the ICB of the BDAV directory, the ICB of subdirectories below, and directory data.

9) The VRS is generated at 16 LBN.

10) Before 512 LBN, P LBN is allocated and the VDS is generated.

11) The AVDP is generated at 256 LBN and at the last LBN.

12) The BDFS file system related information is deleted such that other reproducing apparatuses cannot recognize the existence of the changed BDFS file system.

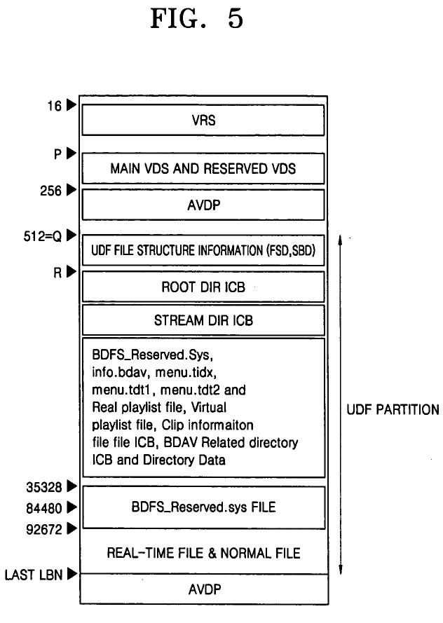

FIG. 5 is a diagram illustrating the result of converting the BDFS format into the UDF format according to an aspect of the present invention.

Referring to FIG. 5, the VRS indicating the UDF file system format is recorded at address 16 LBN area on the disc, the VDS describing information on the volume structure is recorded at arbitrary P LBN area before 256 LBN, the AVDP that is information indicating the location of the VDS is recorded at 256 LBN area and at the last LBN area.

Also, the FSD having the file structure of the UDF file system and the SBD having allocation information are recorded in the UDF partition area from 512 LBN to the last LBN, and the ICB of the root directory and the ICB of the system stream directory are recorded at R LBN area. In the remaining area, the ICB of the special system file, BDFS_Reserved.sys, navigation and image related files stored in group 1 through group 4 of the BDFS before conversion, such as info.bdav, menu.tidx, ICB of the BDAV directory, and so on are recorded.

In the area from 35238 LBN to 92672 LBN, the special system file is recorded so that other files in the UDF format cannot access the area. The actual real-time data and normal data are recorded after the 92672 LBN area.

Reversely, a method of converting the UDF format into the BDFS format will now be explained.

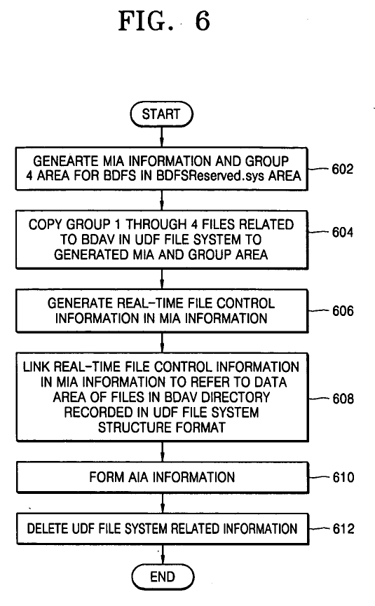

FIG. 6 is a flowchart of the operations performed by a method of converting the UDF format into the BDFS format according to an aspect of the present invention.

Referring to FIG. 6, in order to convert the UDF format into the BDFS format, first, the MIA and group 4 areas for the BDFS are generated in BDFSRerserved.sys area in operation 602. Next, files of group 1 through group 4 related to the BDAV in the UDF file system are copied into the generated MIA and group 4 areas in operation 604. Next, the ICB of the real-time file is generated in the management information of the MIA in operation 606. Also, the control information of the real-time file in the management information of the MIA is linked to refer to the files in the BDAV directory recorded in the UDF file system structure format in operation 608. Next, the AIA is generated in operation 610 and UDF file system related information is deleted in operation 612.

The method of converting the UDF file system format into the BDFS file system format described above can be broken down and summarized as the following:

1) The MIA and group 4 areas are generated in BDFS Reserved area from 35328 LBN to 92671 LBN.

2) The BDAV directory structure in the UDF partition area is converted into management information in the MIA and copied in the BDFS Reserved area.

3) The structure of files of group 1 through group 4 areas in the UDF partition area, including info.bdav, menu.tidx, menu.tdt1, menu.tdt2, mark.tidx, mark.tdt1, mark.tdt2, real playlist, virtual playlist, and clip information, and so on, and the structure of the BDAV directory are copied in the BDFS Reserved area to fit the BDFS format.

4) In the management information in the MIA of BDFS Reserved area, the ICB of m2ts and dvsd files (real-time file) existing in the UDF partition area are generated and this ICB is linked to the address of data stored in the file and directory data area of the UDF file system.

5) The AIA is generated.

6) UDF information is deleted so that other reproducing apparatuses cannot recognize the existence of the changed UDF file system.

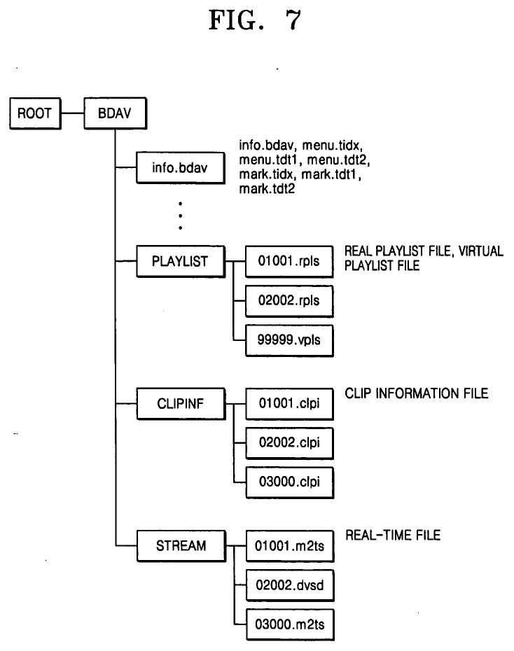

FIG. 7 is a diagram explaining the structure of a root directory used in the UDF format and the BDFS format.

Referring to FIG. 7, the BDAV directory of the root directory includes info.bdav directory storing management information stored in group 1 through group 4 areas, PLAYLIST directory including real playlist and virtual playlist, CLIPINF directory including clip information files, and STREAM directory in which actual moving picture files are recorded.

A method of converting the type of a file used in the file system of the BDFS format into the type of a file used in the UDF format file system will now be explained.

Corresponding to file type information indicating a real-time recording and reproducing file in the conventional BDFS file system format, a value, 249, is set to the tag of the ICB that is file control information, in the converted UDF file system format such that the real-time recording and reproducing file type can be indicated.

A method of converting file extent information implemented in the file system of the BDFS format into file extent information used in the file system of the UDF format will now be explained.

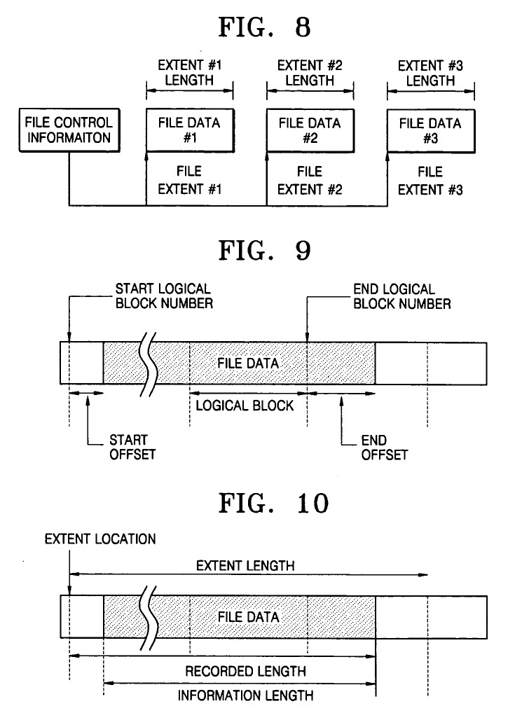

FIG. 8 is a diagram explaining file extent information included in file control information.

Referring to FIG. 8, file control information includes information on the start location of each file data item and the size of the extent of each file data item. That is, through the file control information, the location where file data is recorded and the size of a file can be learned.

FIG. 9 is a diagram showing file extent information in the BDFS format.

While a file extent is allocated in units of sectors in the UDF file system format, a file extent is allocated even in byte units in the BDFS file system format. Referring to FIG. 9, in the BDFS file system format, in order to allocate a file extent in units of bytes, information of a start offset and an end offset is further included in addition to a start logical block number and an end logical block number.

FIG. 10 is a diagram showing file extent information in the converted UDF format according to an aspect of the present invention.

Referring to FIG. 10, in the converted UDF file system format, in order to express the file extent information of the previous BDFS file system format, an extent length, a recorded length and an information length are used.

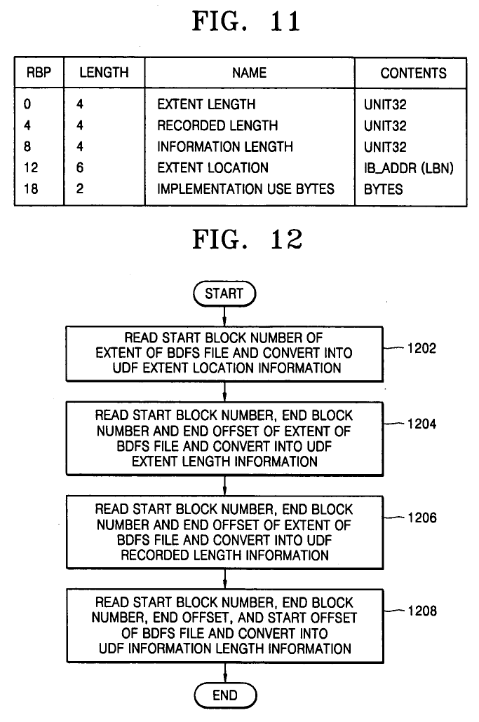

FIG. 11 is a diagram showing an extended allocation descriptor complying with an ECMA 167 standard to implement file extent information in the converted UDF format according to an aspect of the present invention.

Referring to FIG. 11, extended allocation descriptors such as an extent length, a recorded length, an information length, and an extent location, are shown.

A method of converting file extent information in the BDFS file system format into file extent information in the UDF file system format using the extended allocation descriptor described above will now be explained.

FIG. 12 is a flowchart of the operations performed by a method of converting file extent information in the UDF format converted according to an aspect of the present invention.

Referring to FIG. 12, in order to convert file extent information into the UDF format, first the start block number of a file extent in the BDFS format is read and converted into extent location information in the UDF format in operation 1202. Next, the start block number, end block number, and end offset of the file extent in the BDFS format are read and converted into extent length information in the UDF format in operation 1204. Next, the start block number, end block number and end offset of the extent in the BDFS format are read and converted into recorded length information in the UDF format in operation 1206. Finally, the start block number, end block number, start offset, and end offset of the extent in the BDFS format are read and converted into information length information in the UDF format in operation 1208.

Accordingly, the file extent in the BDFS format of FIG. 9 described above can be converted into the file extent in the UDF format of FIG. 10 and expressed.

Meanwhile, the file conversion method according to an aspect of the present invention can be implemented as a computer program. Codes and code segments forming the program can be easily inferred by the programmers in the technology field of the present invention. Also, the program is stored in computer readable media, and read and executed by a computer to implement the method of converting a file system format. The computer readable media includes magnetic recording media, optical recording media and carrier wave media.

While the present invention has been particularly shown and described with reference to exemplary embodiments thereof, it will be understood by those of ordinary skill in the art that various changes in form and details may be made therein without departing from the spirit and scope of the present invention as defined by the following claims. The embodiments should be considered in descriptive sense only and not for purposes of limitation. Therefore, the scope of the invention is defined not by the detailed description of the invention but by the appended claims, and all differences within the scope will be construed as being included in the present invention.

According to an aspect of the present invention as described above, a method and apparatus converting a format between the BDFS format that is a file system used in a Bluray disc and the UDF format that is a universal disc format are provided.

Accordingly, compatibility between a data recording and/or reproducing apparatus complying with BDFS file system format and a data recording and/or reproducing apparatus complying with the UDF file system format can be guaranteed.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

1. A method of converting a first format file system into a second format file system, comprising:
recording data on a predetermined reserved area including a management information area of the first format file system, as system data of the second format file system; and
converting first file data of the first format file system into second file data of the second format file system.

2. The method of claim 1, wherein the first format file system is a Bluray disc file system (BDFS) format recorded on an optical disc and the second format file system is a universal disc format (UDF).

3. The method of claim 2, wherein the recording of the system data of the second format file system comprises:
moving the management information area in the BDFS format into a normal data area in the BDFS format and recording the management information area in the normal data area; and
reserving the predetermined reserved area previously used for the management information area so as to prevent use of the predetermined reserved area by other files.

4. The method of claim 2, wherein the converting of the first file data into the second file data comprises:
by interpreting information recorded in the management information area, generating a file system structure in the UDF format;
linking control information of files in the first file data system in the UDF to the second file data;
generating a volume structure of the UDF; and
deleting information related to the first file data in the BDFS format.

5. A method of converting a second format file system into a first format file system, comprising:
copying information of a management information area of the first format file system recorded as system data of the second format file system, into a reserved predetermined area and
converting second file data of the second format file system into first file data of the first format file system.

6. The method of claim 5, wherein the first format file system is a Bluray disc file system (BDFS) format recorded on an optical disc and the second format file system is a universal disc format (UDF).

7. The method of claim 6, wherein the copying of the information of the management information area of the first format file system into the predetermined reserved area comprises:
generating the management information area in the BDFS format in the predetermined reserved area; and
copying the UDF format management information in the generated management information area.

8. The method of claim 6, wherein the converting into file data of the first format file system comprises:
generating file control information in the management information area;
linking the file control information to file data of the normal data area in the BDFS format;
generating an anchor information area indicating a location of the management information area in the BDFS format; and
deleting information related to the file system in the UDF format.

9. A method of converting a Bluray disc file system (BDFS) format recorded on an optical disc into a universal disc format (UDF) comprising:
converting the extent of a file into the location and length of the extent, a length of a recorded area, and the length of an information area, using a start offset and an end offset; and
converting file data in the BDFS format into file data in the UDF format by using the converted extent.

10. An apparatus providing a conversion function between a first format file system and a second format file system, comprising:
a unit recording on a predetermined reserved area including a management information area of the first format file system, system data of the second format file system;
a unit converting first file data of the first format file system into second file data of the second format file system; and
a unit converting the second file data of the second format file system into the first file data of the first format file system.

11. The apparatus of claim 10, wherein the first format file system is a Bluray disc file system (BDFS) format recorded on an optical disc and the second format file system is a universal disc format (UDF).

12. A method of converting a universal disc format (UDF) file system into a Bluray disc file system format, comprising:
generating a management information area in a reserved area for the Bluray disc file system format;
copying files of the universal disc format file system into the management information area;
generating an information control block (ICB) of a real-time file in the management information area;
linking control information of the real-time file to the files of the universal disc format file system; and
generating anchor information areas adjacent to the management information area.

13. The method of claim 12, wherein the anchor information areas include information indicating an updated location of the management information area.

14. The method of claim 13, wherein the anchor information is recorded at a start part and an end part of a disc.

15. The method of claim 12, wherein the Bluray disc file system format information includes a start offset and an end offset, and a start logical block number and an end logical block number of the Bluray disc file system format.

16. A method of converting a first format file system into a second format file system, comprising:
moving files of the first format file system from a first area to a real-time file data area and a normal file data area;
generating a second format file system structure;
generating root directory information and system stream directory information in a file data area and a directory data area of the second format file system;
linking the root directory information and the system stream directory information of the second format file system to the real-time file data area and the normal file data area of the first format file system; and
generating a volume structure of the second format file system.

17. The method of claim 16, wherein the first format file system is a Bluray disc file system (BDFS) format.

18. The method of claim 16, wherein the second format file system is a universal disc format (UDF).

19. The method of claim 16, wherein the linking of the root directory information and the system stream directory information of the second format file system to the real-time file data area and the normal file data area of the first format file system enables reading of existing data files on the converted second format file system.

20. A computer readable medium encoded with processing instructions for performing a method of converting a first format file system into a second format file system, the method comprising:
moving files of the first format file system from a first area to a real-time file data area and a normal file data area;
generating a second format file system structure;
generating root directory information and system stream directory information in a file data area and a directory data area of the second format file system;
linking the root directory information and the system stream directory information of the second format file system to the real-time file data area and the normal file data area; and
generating a volume structure of the second format file system.

21. The computer readable medium of claim 20, wherein the first format file system is a Bluray disc file system (BDFS) format.

22. The computer readable medium of claim 20, wherein the second format file system is a universal disc format (UDF).

23. The method of claim 1, wherein play list files and clip information files are recorded in the management information area of the first file system.

24. The method of claim 4, wherein the UDF file system structure includes a volume recognition sequence, a volume descriptor sequence, an anchor volume descriptor pointer, file structure, root directory and space bitmap descriptor.

25. The method of claim 8, wherein the file control information includes start location information of the file data and file extent information of the file data.
